(19) United States
(12) Patent Application Publication
(10) Pub. No.: US 2011/0125553 A1
(43) Pub. Date: May 26, 2011

(54) Determining Impact of Change in Specification on Services of Enterprise

(75) Inventors: Pietro Mazzoleni, New York, NY (US); Biplav Srivastava, Noida (IN)

(73) Assignee: International Business Machines Corporation, Armonk, NY (US)

(21) Appl. No.: 12/625,788

(22) Filed: Nov. 25, 2009

(51) Int. Cl. G06Q 10/00

(52) U.S. Cl. 705/7.37

(57) ABSTRACT

Methods, models, apparatus and systems for determining impact of a change in a specification on one or more services to be used by an enterprise are presented. For example, a method for determining impact of a change in a specification on one or more services associated with an enterprise includes obtaining the change in the specification associated with the enterprise, obtaining enterprise elements, obtaining structural rules stating relationships among the enterprise elements, obtaining one or more pre-defined impact rules indicating one or more possible changes associated with the enterprise, and determining the impact of the change in the specification on the enterprise. The one or more pre-defined impact rules have been pre-defined independent of the one or more services to be used by the enterprise. The impact is determined according to the change in the specification, the enterprise elements, the structural rules and the one or more pre-defined impact rules. One or more of obtaining the change in the specification, obtaining the enterprise elements, obtaining the structural rules, obtaining the one or more pre-defined impact rules, and determining the impact are implemented as instruction code executed on a processor device.

### FIELD OF THE INVENTION

The present invention relates to service oriented architecture technology and, more particularly, to techniques for determining an impact of a change in requirement or specification, such as a technical or business domain requirement, on a service oriented architecture.

### BACKGROUND OF THE INVENTION

Service Oriented Architecture (SOA), e.g., web services, is a popular building block for open-standards based information technology (IT), see, e.g., E. Newcomer et al., “Understanding SOA with Web Services,” Addison Wesley (ISBN 0-321-18086-0), 2005, the disclosure of which is incorporated by reference herein. Web services are provided over a network, for example, the Internet.

In general, as is known in computing environments, SOA provides a set of governing concepts used during phases of systems development and integration. Such an architecture packages functionality as interoperable services. Software modules provided as a service can be integrated or used by several organizations, even if their respective client systems are substantially different. Further, it is known that, rather than defining an application programming interface (API), SOA defines the interface in terms of protocols and functionality. Still further, SOA separates functions into distinct units, or services, which developers make accessible over a network in order that users can combine and reuse them in the production of applications. These services communicate with each other by passing data from one service to another, or by coordinating an activity between two or more services.

In SOA, service providers may publish specifications of their IT capabilities wrapped as services onto registries that reside on the World Wide Web, thus the phrase “web services.” Web services make functional building blocks accessible over standard Internet protocols independent of platforms and programming languages. These services can be new applications or services wrapped around existing legacy systems to make them network-enabled. The terms SOA and web services will be used interchangeably herein. The services can assist businesses (more generally, enterprises) to become more responsive to the changing environment in which they operate when they are implemented and used in the context of processes associated with such businesses (known as “business processes”).

### SUMMARY OF THE INVENTION

Principles of the invention provide, for example, methods, models, apparatus and systems for determining an impact of a change in a specification on one or more services to be used by an enterprise.

In accordance with one aspect of the invention, a method for determining an impact of a change in a specification on one or more services associated with an enterprise comprises obtaining the change in the specification associated with the enterprise, obtaining a plurality of enterprise elements, obtaining one or more structural rules stating relationships among the plurality of enterprise elements, obtaining one or more pre-defined impact rules indicating one or more possible changes associated with the enterprise, and determining the impact of the change in the specification on the enterprise. The one or more pre-defined impact rules have been pre-defined independent of the one or more services to be used by the enterprise.

The plurality of enterprise elements, the one or more structural rules, and the one or more pre-defined impact rules are stored in a data structure in the form of a model such that the enterprise elements from a non-technical (e.g., business) domain of the enterprise and the enterprise elements from a technical (e.g., IT) domain of the enterprise that are used to implement the enterprise elements of the non-technical domain, and dependencies there between, are represented in the model.

The impact is determined according to the change in the specification and the model which comprises the plurality of enterprise elements, the one or more structural rules, and the one or more pre-defined impact rules, such that when an enterprise element changes in the model based on the obtained specification change, one or more of the impact rules are used to propagate the change across the model to identify which enterprise elements across the multiple domains are affected.

One or more of obtaining the change in the specification, obtaining the plurality of enterprise elements, obtaining the one or more structural rules, obtaining the one or more pre-defined impact rules, forming the model, and determining the impact are implemented as instruction code executed on a processor device.

In accordance with another aspect of the invention, a system for determining an impact of a change in a specification on one or more services associated with an enterprise is provided. The system comprises modules for implementing the above method.

In accordance with yet another aspect of the invention, a model for determining an impact of a change in a specification on one or more services associated with an enterprise is provided. The model is used in implementing the above method.

In accordance with an additional aspect of the invention, apparatus for determining an impact of a change in a specification on one or more services associated with an enterprise is provided. The apparatus includes a memory and a processor coupled to the memory. The apparatus is operative or configured to perform the above method.

In accordance with another additional aspect of the invention, an article of manufacture for determining an impact of a change in a specification on one or more services associated with an enterprise is provided. The article of manufacture tangibly embodies a computer readable program code which, when executed, causes the computer to implement the above method.

In most businesses, changes affecting business objects and processes occur almost continuously. Aspects of the invention include, for example, precise methods to characterize impacts on service implementations that result from these changes.

Knowing the changes to be made in a complex service oriented architecture has advantage on the business side, by providing an understanding of parts of the business that could be affected by the changes leading to valuable insights for project plans, cost of implementations, and best practices in building customizable services; and on the technical side by identifying tasks that could or should be implemented in the associated system.

These and other features, objects and advantages of the present invention will become apparent from the following detailed description of illustrative embodiments thereof, which is to be read in connection with the accompanying drawings.

### BRIEF DESCRIPTION OF THE DRAWINGS

FIG. 1 illustrates two processes in an example scenario for use in describing one or more embodiments of the invention.

FIG. 2 illustrates an example of a model for business-process driven service oriented architecture implementation according to an embodiment of the invention.

FIG. 3 illustrates an example of business level model elements according to an embodiment of the invention.

FIG. 4 illustrates an example of IT level model elements according to an embodiment of the invention.

FIG. 5 illustrates impact propagation rules according to an embodiment of the invention.

FIG. 6 illustrates a customization analyzer in a decision support system according to an embodiment of the invention.

FIG. 7 illustrates a customization analyzer in a service discovery system according to an embodiment of the invention.

FIG. 8 illustrates a flow for a method of determining an impact of a specification on one or more services to be used by an enterprise according to an embodiment of the invention.

FIG. 9 illustrates a service protocol in which multiple versions of the same service are offered.

FIG. 10 illustrates facts and structural rules formed according to an embodiment of the invention for the service protocol referred to in FIG. 9.

FIG. 11 illustrates a computer system in accordance with which one or more components/steps of the techniques of the invention may be implemented according to an embodiment of the invention.

### DETAILED DESCRIPTION OF PREFERRED EMBODIMENTS

It is realized that changes can happen anytime in the SOA infrastructure of an enterprise. Illustrative principles of the invention address such changes. It is to be understood that the term “requirement” is commonly used to represent a capability requested by a customer while the term “specification” is commonly used to represent the capability of a system built to satisfy the customer's request. As used herein, the terms requirement and specification have the same meaning, both terms used broadly to include capability requested by a customer and capability of a system built to satisfy the customer's request.

As used herein, the term “enterprise” is understood to broadly refer to any entity that is created or formed to achieve some purpose, examples of which include, but are not limited to, an undertaking, an endeavor, a venture, a business, a concern, a corporation, an establishment, a firm, an organization, or the like. While illustrative embodiments of the invention may refer to a “business,” it is understood that a “business” is only one example of an enterprise, and principles of the invention apply more generally to enterprises.

As used herein, an “enterprise specification” is a specification or proposed specification for an enterprise or a business. By way of example only, an enterprise specification may include one or more changes related to the enterprise; a customization of services requirement for services used, proposed or considered to be used by the enterprise; an enterprise element; and an enterprise fact. It is understood that use of the term “specification” may have a broad meaning that includes “a change in a specification.”

A change in a specification may be, for example, a change in a business and/or technical specification or requirement. It is to be understood that a change in a specification may comprise a modification of an existing specification, or it may comprise introduction of a new specification.

“Enterprise processes” (EP) are processes that the enterprise performs in the course of attempting to achieve the above mentioned purpose of the enterprise. Thus, the phrase enterprise process is understood to broadly refer to a collection of interrelated tasks relevant to an enterprise. The phrase “business process” (BP) is understood to broadly refer to a collection of interrelated tasks relevant to a business (e.g., relevant to a business that is an enterprise). By way of one example only, enterprise processes may comprise business processes. A business process is also an enterprise process. A process invoice order and a general ledger are examples of business processes and, thus, are also considered examples of enterprise processes.

Similarly, the phrase “enterprise object” (EO) is understood to broadly refer to a generic item relevant to an enterprise, and the phrase “business object” (BO) is understood to broadly refer to a generic item relevant to business. By way of example only, enterprise objects may comprise business objects. A business object is also an enterprise object. A customer or an invoice are examples of business objects and, thus, are also considered examples of enterprise objects.

In the discipline of logic, as the discipline relates to computer science, assertions are made about the world in terms of logical statements and associated inferences (inferencing). Inferencing is a technique to draw conclusions from the assertions. Inferencing is used to discover hidden information about the world being modeled. Aspects of the invention include the technique of inference.

Enterprise or business facts, simply referred to as “facts,” represent claims related to the enterprise or business (e.g., claims about a problem universe). Claims may be, for example, true or false. However, there are alternative logical formalisms which allow more than two values (e.g., true or false) for logical assertions. Methods according to embodiments of the invention, and considering known art in logic programming, seamlessly extend to include these alternative logical formalisms. Facts may include, for example, claim about BOs, BPs, and their implementing services and messages of interest. Facts can be extracted by an analyzing IT system or by a subject matter expert (SME). A SME may be a person who is an expert in a particular subject matter area, but not necessarily with technical knowledge about a specific project related to the subject matter area. Facts are one type of enterprise or business element (see below).

“Structural rules” are rules describing or defining relationships among or between facts or other elements (i.e., business or enterprise elements). Structural rules can be extracted by an analyzing IT system or by an SME.

As used herein, an “enterprise element” is a broad term referring to aspects or components of an enterprise. Enterprise elements include, but are not limited to, one or more of any of the following: an enterprise object, an enterprise scenario, an enterprise process, enterprise logic describing an enterprise process, a service used by the enterprise, a service container referring to services used by the enterprise, service logic describing a process flow among services used by the enterprise, a message, a message container, and an enterprise fact. Similarly, as used herein, a “business element” is a broad term referring to aspects or components of a business. Business elements include, but are not limited to, one or more of any of the following: an business object, an business scenario, an business process, business logic describing an business process, a service used by the business, a service container referring to services used by the business, service logic describing a process flow among services used by the business, a message, a message container, and a business fact. Because a business is also an enterprise, business elements are also considered enterprise elements. By way of example only, an enterprise element, or at least a portion thereof, may be provided by a service. For example, a business order process may be provided by a web service.

Given that, in any business, changes that can affect business objects and business processes will continuously happen, illustrative embodiments of the invention provide precise methods that can characterize the impact of these changes on related services (e.g., existing services; specifically, web or Internet services) implementation. The business changes rarely impact a single service. Today, the business to IT alignment is implicit and it is extremely difficult to precisely determine the major changes from the minor ones.

Knowing the changes to be made in a complex SOA brings several advantages. On the business side, it provides an understanding on the parts of the businesses which could be affected by the new requirement (i.e., change or enterprise specification) leading to valuable insights for project planning, cost of implementation, and best practices in building customizable services. On the technical side, it supports software engineers in identifying which tasks should be implemented in the system. Customization or adaption of services (e.g., existing services), and methods thereof, may impact, for example, cost of a change in a business or enterprise; cost of customization of the services; approaches (e.g., alternate approaches) for adaption or customization of services including determination of such approaches; business or enterprise scenarios, processes and objects including scenarios, processes and objects of other businesses; approaches (e.g., alternate approaches) for IT transformation (e.g., service creation, discovery, and composition); and quality of service (e.g., performance and availability). Methods and systems according to certain embodiments of the invention may have built-in models for packaged middleware (e.g., SAP, Oracle, Complete Business Systems (CBS) and RosettaNet).

Illustrative embodiments of the invention also provide methods for personalization and adaptation of web services (e.g., existing web services). Personalization specifies how to modify the content output from a web service specific to the user at runtime whereas behavior adaptation specifies how to modify the behavior of a deployed web service at runtime based on environmental considerations. A new service is neither created nor deployed for the unique service request. Customization of services may be according to an enterprise specification that may be associated with a change in an enterprise or a new enterprise. Customization of services may include, for example, obtaining impact rules which may indicate: aspects of an enterprise which may be affected by the enterprise specification; tasks which should be implemented by the enterprise to meet the enterprise specification; how to modify output content from the services to meet the enterprise specification; and how to modify the behavior of the services to meet the enterprise specification.

The remainder of the detailed description will flow as follows. First, preliminary considerations on service customization are described, followed by a description of a motivational scenario to present certain issues in customization, and then a presentation of a model for customization. Then, an implementation of the customization model is described, followed by a description of an application of the model to a complex services scenario.

When a requirement for a service arises, it can be addressed by building a new service or customizing an existing one. By customization or adaption of web services, we refer to the process by which the behavior of existing web services can be modified to meet the requester's requirements. Specifically, in this illustrative embodiment, we consider customization or adaption as: building parameterized service interfaces so that they can capture a wide range of situations (template); building extensibility mechanisms in the middleware (e.g., proxy) to integrate and extend available services to meet new requirements unanticipated by the service provider, and/or creating a new customized service instance that is deployed specifically for the unique service requester (and may later be used for others as needed). Customization or adaption is typically an offline activity unless the middleware supports the new customized service to be deployed on-the-fly (see, e.g., H. Liang et al., “A Policy Framework for Collaborative Web Service Customization,” Proc. SOSE (2006), the disclosure of which is incorporated by reference herein).

While any service can be customized in theory to meet any requirement, doing it indiscriminately runs the risk of ending up in the registry with a proliferation of service versions that are not appreciably distinct from each other. Hence, deciding to build a new service and deciding to customize an existing service should be used as complementary strategies.

Service providers try to cover as much of the differences as they can anticipate using some of the following techniques:
Parameterization. Here, the actual parameters of the service can be modified based on the data in the arguments;
Function overloading. Here, multiple instances of the same operation are defined with different set of arguments;
Templatization. Here, a service template is available to capture the typical service of interest. Users are guided to select parameters to instantiate the template and create the service matching their requirements.

However, a provider cannot anticipate all types of requirements from potential consumers. The types of differences that can appear between the requirements of a requester and the available services from a provider can be along business objects, processes, services and messages.

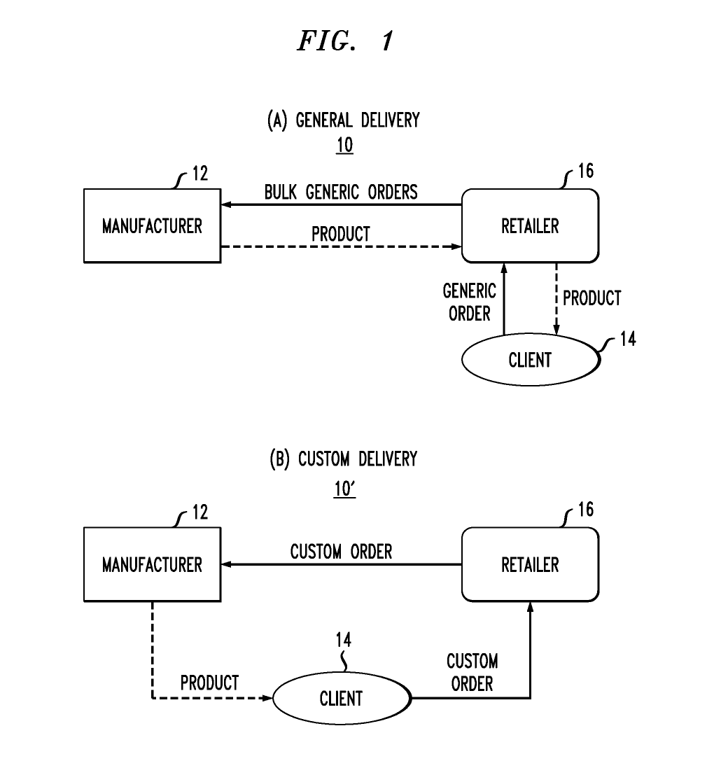

FIG. 1 presents a common scenario to motivate the problem. Consider a simplified electronic commerce (e-commerce) business process for product supply-chain, called General Delivery (10) where a manufacturer M (12) sells products to its clients C (14) via retailers R (16), see FIG. 1(a). C could place an order for the product with R and get its delivery. R on its part can periodically place bulk orders with M and take delivery to replenish its inventory.

It is to be understood that, in an e-commerce embodiment, the blocks shown in FIG. 1 and the subsequent figures represent hardware and/or software components of computers that operate within a computing system environment and communicate over a communication network. For example, the blocks may represent a client service operating on a client computing device (client 14) and servers (respectively associated with manufacturer 12 and retailer 16) represent corresponding services that communicate via the Internet.

Suppose that some clients want to place custom orders which are different from general products. A typical example is for an apparel manufacturer to allow customers to provide their own logo on the shirts they order. The manufacturer now wants to change the supply-chain slightly to allow these clients to be able to place their custom orders and get the products delivered. Custom orders can still be delivered from M to C through R. However, because custom orders take time to build, M may want to ship the product directly to C in a new business process called Custom Delivery (10′). Such process for custom orders is shown in FIG. 1(b).

The business changes in the scenario come from:

1. Changes in the business objects: Custom orders are now introduced.

2. Changes in the business process: The product now can be shipped to both R and C via General Delivery and Custom Delivery processes, respectively. Orders from R can now be both periodic for general products and occasional (nonperiodic or unexpected) for custom products.

3. The changes in the business object and processes could lead to changes in the interfaces of IT services used to implement them (e.g., OrderPlacementService, ProductTrackingService) and the messages involved in their communication.

Changes 1 and 2 above are business changes necessitated by real-world events. We want to take them as inputs and automatically determine business and IT changes as shown in change 3 for the specific SOA implementation (at the manufacturer in the example).

We now introduce the model capturing properties and relationships of a business-process (more generally, an enterprise-process) driven SOA implementation according to an illustrative embodiment of the invention. The model comprises facts and rules. As previously mentioned, facts represent claims related to an enterprise or business, for example, claim about BOs, BPs, and their implementing services and messages of interest. The claims may be true or false.

Rules are used to encode relationships among facts and to infer new facts from the ones in the model. Using the same model, we propose a set of rules to compute the overall impact of a new business requirement spanning both business and IT domains.

While principles of the invention are not limited thereto, in one or more illustrative embodiments, logic programming is used to define the model (e.g., the model comprises logic programming). Specifically, we use S models or stable models (see, e.g., I. Niemelä et al., “S models—an implementation of the Stable model and well-founded semantics for normal 1p,” Proceedings of the 4th International Conference on Logic Programming and Nonmonotonic Reasoning, London, UK, Springer-Verlag, 1997, pp. 421-430, the disclosure of which is incorporated by reference herein in its entirety), an implementation of stable model semantics (see, e.g., M. Gelfond et al., “The stable model semantics for logic programming,” Proceedings of the Fifth International Conference on Logic Programming, Cambridge, Mass., The MIT Press, (1988), pp. 1070-1080, the disclosure of which is incorporated by reference herein in its entirety) and well-founded semantics (see, e.g., A. van Gelder et al., “The well-founded semantics for general logic programs,” Journal of the ACM, Vol. 38, No. 3, (1991), pp. 620-650, the disclosure of which is incorporated by reference herein in its entirety) for normal logic programs. An answer to a problem is a set of facts, called a stable model, which tell which facts are true.

Consider that one can define an industry in terms of a collection of scenarios describing what the enterprise does and how (e.g., how the enterprise functions). There can be cross-industry scenarios which describe the common activities any enterprise has to perform regardless of its area of business (e.g., Annual tax filing). Then there are activities specific to particular industry like prepare clinical trial for Healthcare or emission management for Mining.

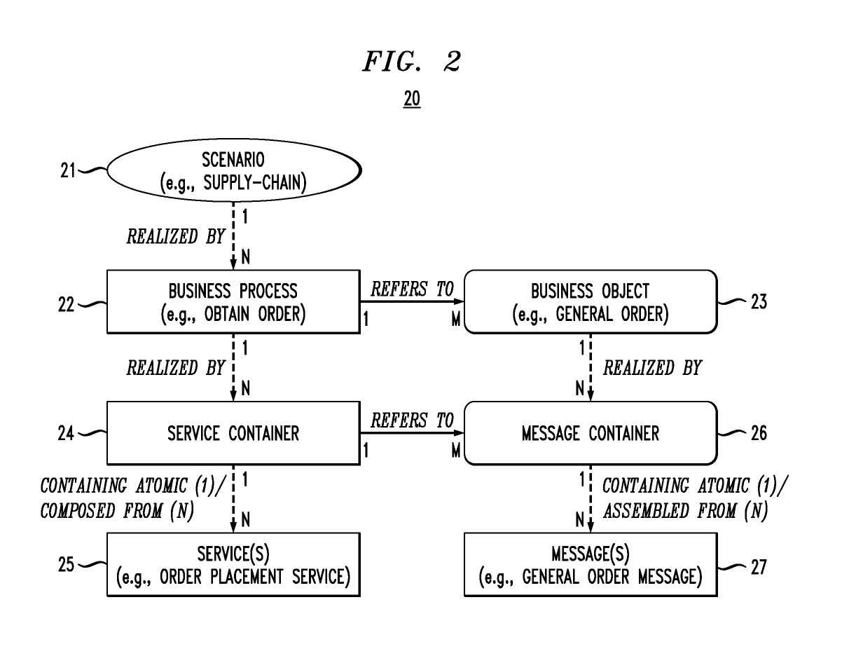

In FIG. 2, we present a simplified model 20 for business-process driven SOA implementation according to an embodiment of the invention. It is to be appreciated that the model is stored as a data structure that can be accessed (obtained) when needed. Note also that while we generally refer to “enterprise elements” herein, we explicitly separate enterprise elements that are business-based from enterprise elements that are IT-based or technical-based, and we use directional arrows (as shown in FIG. 2) to indicate dependencies (i.e., relationships) between such elements. It is to be understood that business-based elements such as business processes and business objects are elements that are considered part of the business (or non-technical) domain of an enterprise. This is to be compared with elements in the IT or technical domain such as software, middleware, and hardware elements (or combinations thereof) that are part of the IT system architecture used to implement the business-based elements. That is, the IT (technical) domain elements such as service containers and message containers are used to realize the business (non-technical) domain elements such as business processes and business objects. The exemplary model in FIG. 2 illustrates this concept.

At a business level, an enterprise domain is decomposed into multiple scenarios. Each scenario 21 (e.g., supply-chain) is realized by one or multiple BPs 22 and by one or multiple BOs 23. Each BP is defined, at least in part, by business logic and references to BOs. Business logic describes the associated BP (enterprise logic describes associated EP). Each BO can be referred by multiple processes as well as by other BOs. In model 20, we denote business scenarios, BPs, business logic, and BOs as facts (and therefore elements) whereas we use structural rules to define rules capturing relations between facts (elements).

### EXAMPLE 1

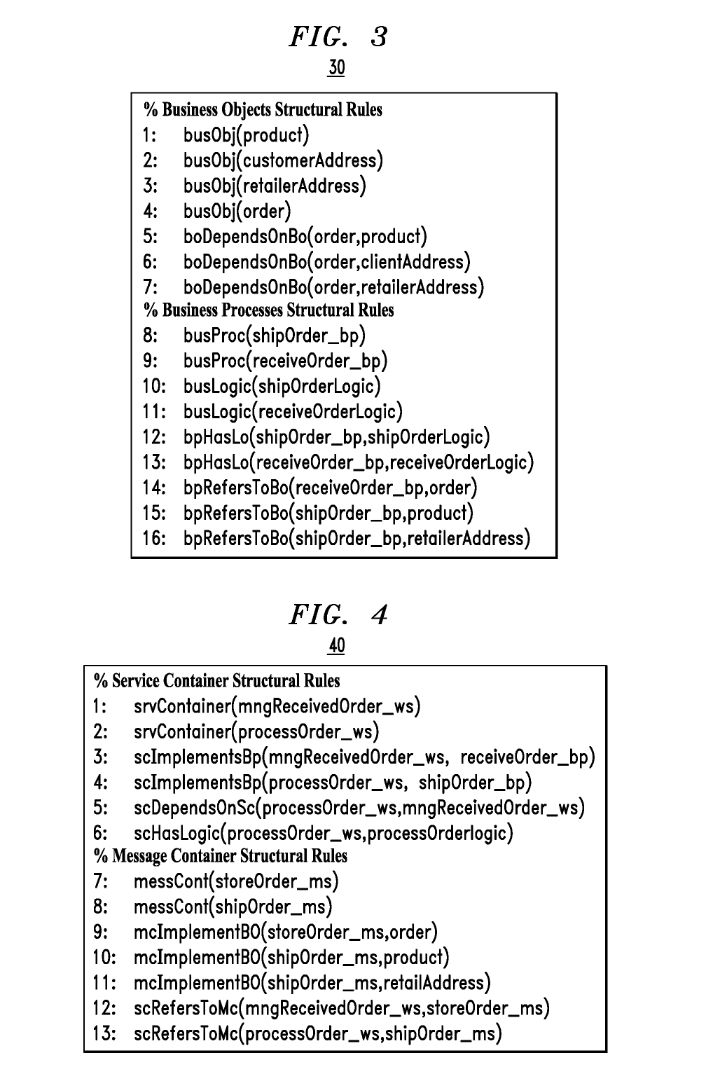

Consider the General Delivery scenario presented in FIG. 1(a). For the sake of illustration, we can assume the domain of interest to be represented by four BOs called product, customerAddress, retailerAddress, and order, and two BPs called receiveOrder_bp and shipOrder_bp. The former BP collects new orders whereas the latter loads existing orders and prepares new shipments. The business logics of the two BPs are defined in shipOrderLogic and receiveOrderLogic, respectively. FIG. 3 shows facts and structural rules (30) composing our simple model. Facts include the business objects listed in lines 1-4, the business processes listed in lines 8-9, and the business logics listed in lines 10-11. Structural rules are structural rules on lines 5-7 related to business objects and structural rules on lines 12-16 related to business processes. As an example, structural rule No. 14 tells that BP receiveOrder_bp refers to (e.g., uses as part of its logic) BO order.

At an IT level, each BP is realized by a service container 24 (SC) referring to one or multiple (web) service(s) 25. In case a SC refers to multiple services (due to service composition), it also connects to a service logic describing the process flow among those services. In addition, each SC refers to one or multiple message containers (MC) 26 describing atomic or aggregate messages 27 that constitute its inputs and outputs. Messages are IT realizations of BOs in specific formats of interest (e.g., order information in Extensible Markup Language (XML) format). Once again, we use facts to generally indicate the base element of the model (i.e., SCs, services, service logics, MCs, and messages) and structural rules represent existing relations among facts.

Thus, a business process is associated with a business object and a service container. The business process may also be associated with a message container, service logic and business logic.

### EXAMPLE 2

FIG. 4 shows facts and structural rules (40) modeling the IT aspects of our simple SOA example of FIG. 2 for the General Delivery scenario presented in FIG. 1(a).

We assume two SCs exist: mngReceivedOrder_ws and processOrder_ws (see facts expressed on lines 1-2). The first SC implements receiveOrder_bp BP while the latter implements shipOrder_bp BP (see structural rules expressed on lines 3-4). In FIG. 4, structural rule No. 5 states that processOrder_ws depends on MngReceivedOrder_ws which means that the first SC is a composed service using, among others, some of the messages referred by the second SC. The logic of the SC is captured in processOrderlogic (see structural rule expressed on line 6).

On the message side, two MCs exist, one for each SC (see facts expressed on lines 7 and 8). storeOrder_ms represents the operation of accepting new orders (defined using BO order; see structural rule expressed on line 9) whereas shipOrder_ms is in charge of creating a new shipment (defined using BO product; see structural rule expressed on line 10).

SC and MS are consistent with web services standards. SC can be represented by a Web Services Description Language or WSDL (see Web Services Description Language (WSDL) Version 2.0 Part 1: Core Language, W3C Recommendation, Jun. 26, 2007, the disclosure of which is incorporated by reference herein in its entirety) and stands for an atomic service or a composite service. The latter logic can be described by abstract Business Process Execution Language or BPEL (Web Services Business Process Execution Language Version 2.0, WS Specification, Aug. 23, 2006, the disclosure of which is incorporated by reference herein in its entirety). The MC represents messages in WSDL for both simple and complex message types.

In a model according to embodiments of the invention, definitions of services and messages are intentionally kept simple. This is because relationships between business and IT elements of a SOA are of interest, more than extensively representing all details of a SOA implementation. Existing standards, such as OWL-S (see, e.g., D. Martin et al., “Bringing semantics to web services: The owl-s approach,” 2004, the disclosure of which is incorporated by reference herein in its entirety) or broadly used ontologies like SAP Global Data Type (GDT) (see, e.g., S. Campbell et al., “Mastering Enterprise SOA with SAP NetWeaver and mySAP ERP,” John Wiley & Sons, Inc., New York, N.Y., USA, 2006, the disclosure of which is incorporated by reference herein in its entirety), can be used for more refined models.

The model is now extended to include impact rules to encode the customization behaviors of a SOA implementation (e.g., to encode the desirable propagation of customization). When triggered by a new customization requirement or specification (e.g., create a new BO for custom order), impact rules can precisely scope the overall impact of the requirement to the SOA, spanning both business and IT domains. Therefore, impact rules may relate to or affect a business domain and/or an IT domain.

In a model according to an embodiment of the invention, we view customization or adaption changes as BO and BP driven impacts on implementing services and messages. When a business element of the model changes, impact rules are used to propagate such change across the model to identify which (business and IT) elements will be affected. Similarly, customization or adaption changes can be driven from IT elements (business and services) and impact business.

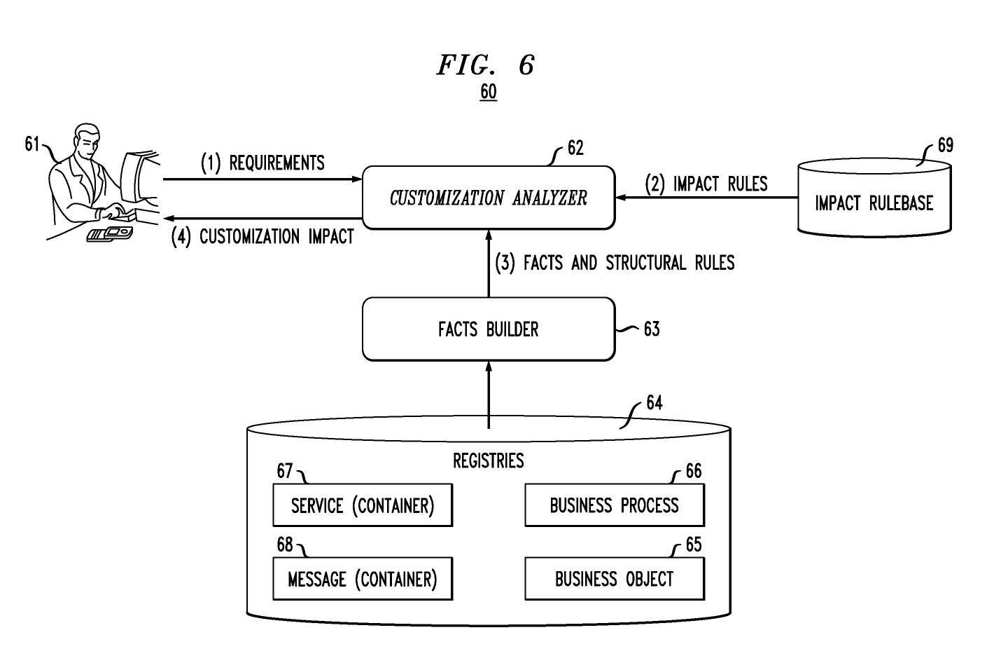

Impact rules may be, for example, pre-existing and/or generally applicable rules that have been defined independent from a specific SOA implementation to which the impact rules are being applied. Impact rules may be, for example, pre-defined impact rules obtained for a database, for example, form impact propagation rule database 69 of FIG. 6. Alternately or additionally, impact rules may be formed by methods of the invention, for example, by analysis of dependencies of enterprise elements and/or structural rules. Impact rules may be, for example, defined using logic programming and may reflect the dependencies depicted in FIG. 2. An inference engine may be used to compute the overall impact of a new business requirement. An embodiment of such an inference engine will be described below in the context of FIG. 6. Inputs to the inference engine may comprise: a) elements such as facts defined for the specific SOA implementation; b) structural rules defined for the specific SOA implementation; c) impact rules, defined independently from any SOA implementation; and d) the new business requirements expressed as additional facts for the model (e.g., changeBusObj (order)).

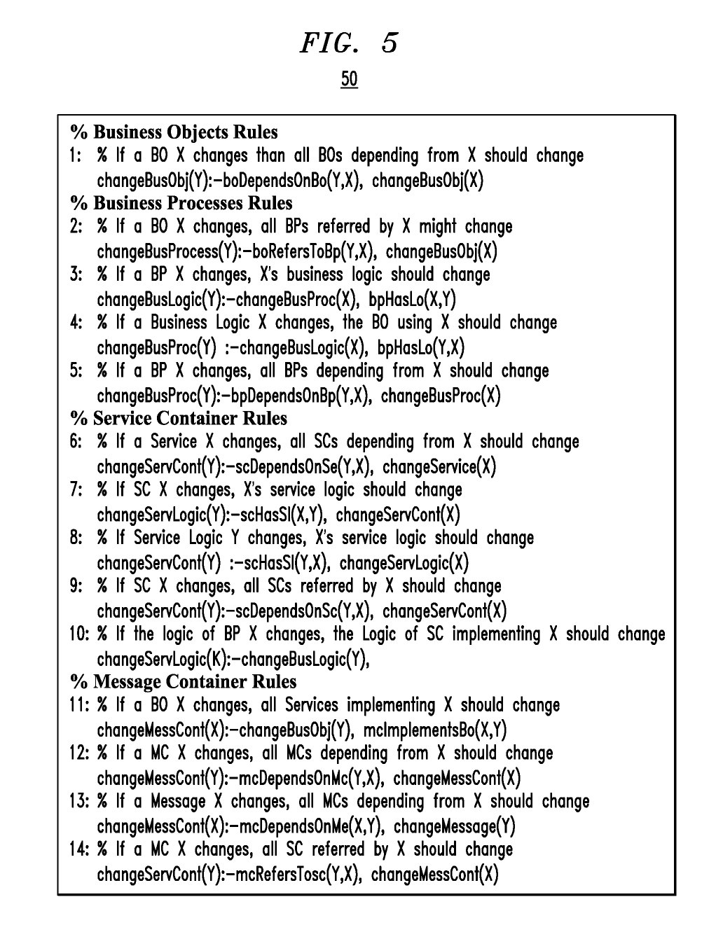

FIG. 5 presents the list of impact propagation rules (50) we defined using S model. For example, rule No. 1 (changeBusObj (Y): -boDependsOnBo (Y,X), changeBsObj (X)) would tell that if BO Y depends on BO X and BO X changes, then BO Y will change. In the example, X and Y are variables whose values are not defined by the user but rather inferred by the engine starting from facts either in the model or inferred from evaluating other rules.

In what follows, we use an example to describe how the rules compute the overall impact of a new customization requirement.

### EXAMPLE 3

Consider once again the scenario introduced above in the context of FIG. 1. The business requirement (specification) can be modeled with two facts: changeBusObj (order), to represent the need to distinguish between custom and general orders, and changeBusLogic (ShipOrderLogic) to represent the change in the business logic for handling custom orders. Note there is not a predefined order according to which rules should be evaluated. Instead, the inference engine analyzes all possible combinations of facts searching for stable models. On the business side, changeBusObj (order) propagates through impact rule No. 2 of FIG. 5 to change the receiveOrder_bp, i.e., changeBusProc (receiveOrder_bp), via the structural rule on line 14 of FIG. 3 stating that receiveOrder_bp refers to BO order. Similarly, changeBusObj (order) propagates through the change in recieveOrder_bp and impact-rules No. 3 of FIG. 5, to business logic processOrderlogic. As result, the engine will introduce two new facts: changeBusProcess (receiveOrder_bp) and changeBusLogic (processOrderlogic).

On the IT side, rule No. 10 (FIG. 5) propagates the impact of the change, i.e., propagates the change “changeBusLogic (processOrderlogic),” to changeServLogic for process order logic. The changeServLogic propagates through rule No. 8 (FIG. 5) to changeServCont (processOrder_ws) (see fact of line 1 and structural rule of line 6 of FIG. 4). Whereas rule No. 11 (FIG. 5) extends the impact of the change, i.e., extends the change “changeBusObj (order),” to changeMessCont (storeOrder_ms) (see fact of line 7 and structural rule of line 9 of FIG. 4). Finally, rule No. 14 (FIG. 5) takes as input changeMessCont(storeOrder_ms) and propagates the impact of the requirement to changeServCont (mngReceivedOrder_ws) (see fact of line 1 and structural rule of line 12 of FIG. 4).

As result of the inferencing process, the inference engine highlights two different actions for the two SCs in the model: a change to the service logic of SC processOrder_ws and a change for message (storeOrder_ms) in case of SC mngReceivedOrder_ws. Such actions are specific to the facts and structural rules defined in the examples above and would have been different in case of a different SOA implementation.

The impact propagation rules (impact rules) presented in FIG. 5 represent the “sufficient but not necessary” set of changes to be considered as result of a new business customization requirement. It is so because all possible changes in the SOA are identified. However, even though the scope of changes is known, a system architect might decide not to take action as result of the new business requirement based on assessments that are not captured in the model. As an example, a system architect might decide not to change a service message until it is used as part of a business process. Again, even if a BO A becomes irrelevant for the business, a system architect might choose not to change service messages implementing A but simply ignore the content when appears in the services. To better inform the system architect on the changes to be made on the SOA implementation, we can refine the model introducing the concept of “type of change.” In an extended version of our model, business requirements are defined not only with the affected element (e.g., BO—product) but also with the type of change to implement (e.g., add new BO). Similarly, impact rules are extended to consider the type of change when propagating a new requirement across the model.

We now describe an illustrative implementation for business-process driven service customization according to principles of the invention. Recall that the solution to the customization comprises three key components—(a) Facts—a set of claims about BOs, BPs, and their implementing services and messages of interest, (b) Structural rules—rules capturing properties and relationships among facts, and (c) Impact rules—universal rules encoding the desirable propagation of customization behavior in the model. A logic checker works with the facts and the rules to make decisions on what needs to be customized.

FIG. 6 illustrates a decision support system 60 according to an embodiment of the invention. Assume user 61 wants to inquire about the impact of some business events (e.g., a requirement or specification). The customization analyzer component 62 translates the requirements to facts. The fact builder component 63 computes enterprise elements (e.g., facts) and structural rules of the SOA instance based on existing registries for known BOs 65, processes 66, services 67 and messages 68. Note that current web service standards do not require all messages to be explicitly registered but rather that they are addressable and accessible through uniform resource identifiers (URIs). Hence, they could be considered optional for the model. The impact rulebase component 69 contains the impact rules. The customization analyzer 62 uses the facts and the rules collectively from the requirements, the fact builder 63 and the impact rulebase 69 to determine what services could be customized to meet the requirement (enterprise specification). In general, the customization analyzer 62 can generate a model or access (obtain) a pre-stored (i.e., stored as a data structure) model and/or some of its components, based on the input received, in order to generate the customization impact results.

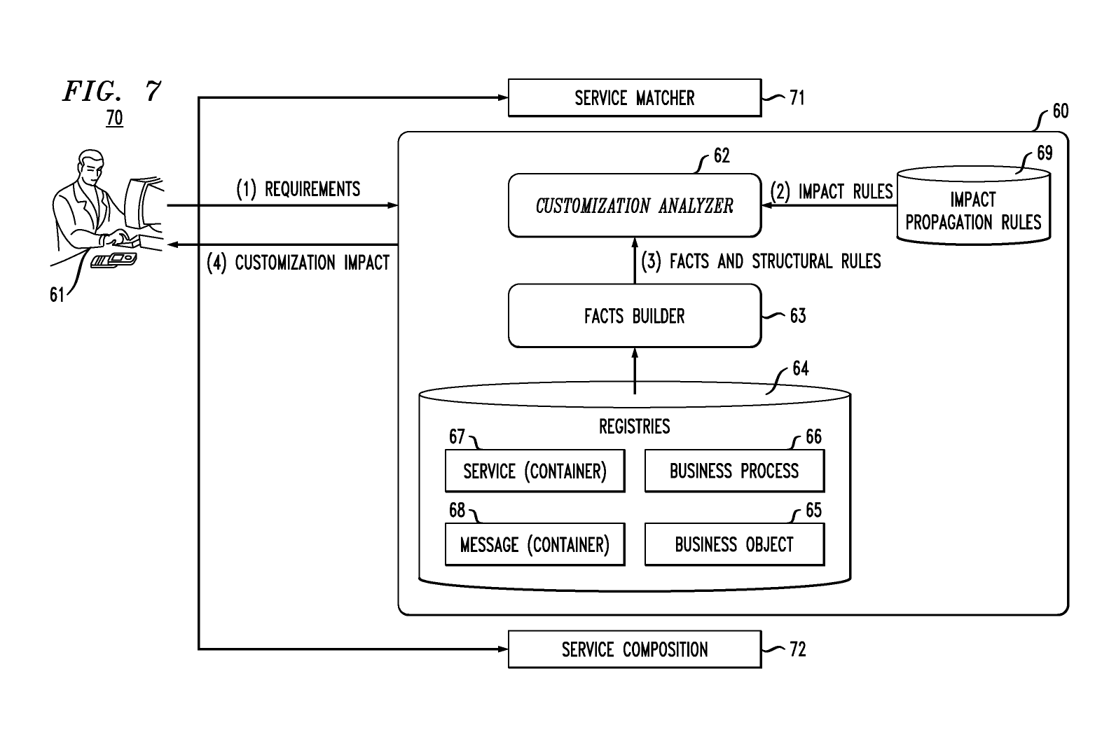

FIG. 7 illustrates an application of the decision support system 60 of FIG. 6 with other service discovery tools. Here, the problem being addressed is how a client could find a service that can meet its request or enterprise specification (in the beginning or as part of a continuous relationship). One approach is to use a service matchmaker tool 71, as is known, to find potential existing services that can handle the request. Now, decision support system 60 can be used to find whether any of the potential services returned by service matching, if such services can not directly handle the request, can be customized to handle the request. If this is not possible, a service composition tool 72, as is known, can be used to find a collection of existing services that can handle the client's request.

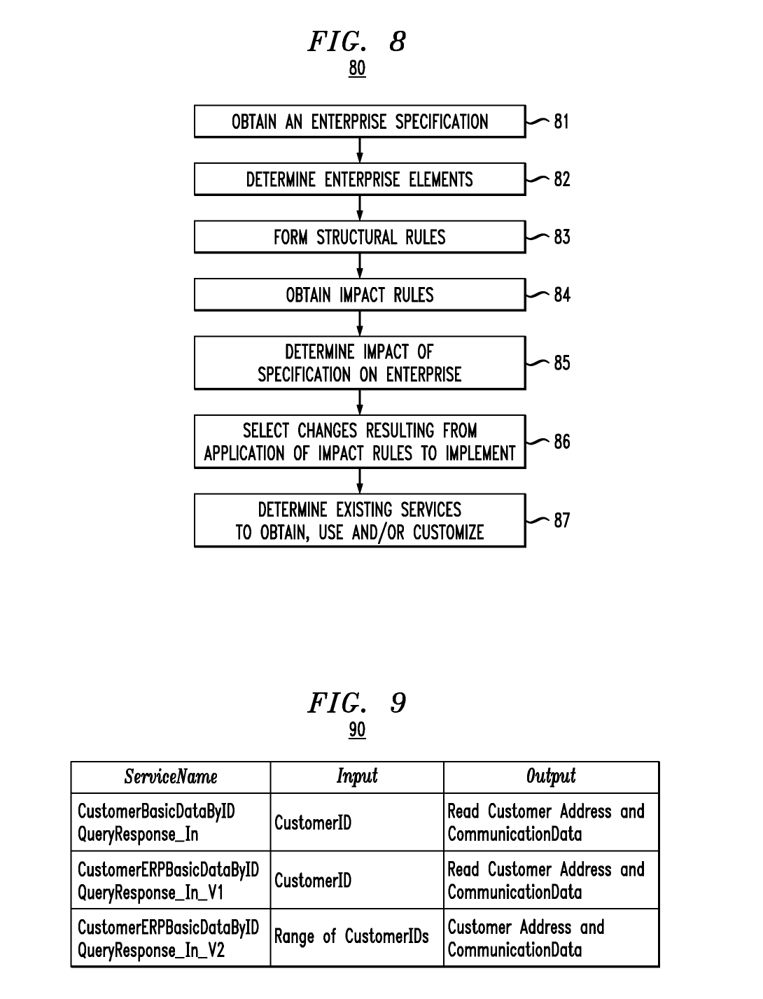

FIG. 8 is a flow diagram of a method 80 for determining an impact of a specification, or a change in a specification, on one or more services to be used by an enterprise according to an embodiment of the invention. Method 80 may further include obtaining (e.g., finding, modifying, personalizing, customizing and/or adapting) one or more services to meet needs of an enterprise, the needs expressed by a specification. By way of example only, method 80 may be used to find, modify, adapt personalize and/or customize an existing service. The services may comprise, for example, web (Internet) services or services associated with SOA. All or any part of the process may occur or be implemented on a processor device coupled to a memory.

Step 81 comprises obtaining an enterprise specification associated with the enterprise that is to obtain and potentially use the one or more services. It is understood that obtaining the specification may, but not necessarily, include obtaining a change in an existing specification, and that specification may or may not have a broad meaning that includes the change in a specification. The enterprise specification may, for example, express a change associated with an enterprise or may express requirements of a new business. The enterprise specification, or change thereof, may comprise, for example, a change related to the enterprise, a new enterprise requirement or specification, a customization of services requirement, an enterprise element, an enterprise fact, a change in a business object, and a change in a business process. The specification may, for example, be expressed as, or be transformed into, additional enterprise facts.

Step 82 comprises determining enterprise elements. The enterprise elements may, for example, be one or more of: an enterprise object, an enterprise scenario, an enterprise process, enterprise logic describing the enterprise process, a service, a service container referring to at least one service, service logic describing a process flow among the at least one service, a message, a message container, and an enterprise fact. Determining the enterprise elements may, for example, be according to one or more registries of known enterprise objects, known enterprise processes, known enterprise services, and known messages. The enterprise elements may be, for example, determined by the fact builder 63 of system 60. The enterprise elements may comprise, for example, enterprise facts defined for a specific SOA implementation

Step 83 comprises forming structural rules. The structural rules state relationships among the enterprise elements. Determining the structural rules may, for example, be according to one or more registries of known enterprise objects, known enterprise processes, known enterprise services, and known messages. The structural rules may be, for example, determined by the fact builder 63 of system 60. Structural rules are defined for specific SOA implementations.

Step 84 comprises obtaining impact rules. The impact rules state possible changes in the enterprise, the one or more services, implementation of the one or more services, enterprise elements and/or structural rules. Impact rules may be, for example, pre-existing and/or generally applicable rules that have been defined independent from a specific SOA implementation to which the impact rules are being applied (e.g., defined or formed independent from the one or more services associated with the change in specification). Impact rules may be, for example, pre-defined impact rules obtained for a database, for example, form impact propagation rule database 69 of FIG. 6. Alternately or additionally, impact rules may be formed or determined by methods of the invention, for example, using an S model (Stable model) or by analysis of dependencies of enterprise elements and/or structural rules. Impact rules may be defined using logic programming and may, for example, reflect the dependencies depicted in FIG. 2. Impact rules, along with the specification and the structural rules may be used to determine which existing services to use, adapt, customize, personalize or otherwise modify to meet the needs of the enterprise or business. The impact rules may assist in indicating, for example, an aspect of the enterprise which may be affected by the specification or a change thereof, a task which should or could be implemented by the enterprise to meet the specification or a change thereof, how to modify output content from the services to meet the specification or a change thereof, and how to modify behavior of the services to meet the specification or a change thereof. Exemplary impact rules are listed in FIG. 5. Note that impact rules may be formed or defined independent of any specific SOA implementation, and be generally applicable to a broad range of SOA implementations.

Step 85 comprises determining the impact of the specification on the enterprise, for example, on the one or more services of the enterprise, or implementation thereof. The impact may be determined according to the specification, the enterprise elements, the structural rules and the impact rules. An inference engine may be used to compute the overall impact of the specification. Inputs to the inference engine may comprise the enterprise elements, the structural rules, the impact rules, and the new business requirements expressed as the specification. The determining of the impact may comprise, for example, determining possible changes to the enterprise, the services, implementation of the services, business elements and/or structural rules.

Step 86 comprises determining or selecting which of the possible changes resulting from the application of the impact rules (step 85) to implement. The possible changes comprise, for example changes related to the one or more services or implementation thereof. Step 85, for example, may determine all possible changes resulting from the specification, thus, representing a “sufficient but not necessary” set of changes to be considered as result of the specification. It is so because all possible changes in the SOA may be identified. However, even though the scope of changes is known, it may be decided not implement one or more of the possible changes, for example, on assessments that are not addressed by method 80 or captured in an associated model.

Step 87 comprises determining one or more existing services to obtain, use or customize to meet the enterprise specification. In one embodiment of the invention, the service(s) to obtain, use or customize may be determined prior to any or all of steps 82 through 86. In another embodiment of the invention, steps 81 through 86 are performed to determine which service(s) to obtain, use or customize. In this embodiment, the service(s) to obtain, use or customize is not known until after obtaining the impact rules (step 84). By way of example only, determining the existing services to obtain, use or customize may be performed by the customization analyzer 62 using the facts and the rules collectively from the enterprise specification, the fact builder 63 and the impact rulebase 69 to determine what services could be obtained, used or customized to meet the enterprise specification. Also by way of example only, system 70 may also be used to determine existing services to obtain, use or customize.

A model for obtaining services parallels method 80. The model comprises the enterprise elements, the structural rules stating the relationships among the enterprise elements, and the impact rules stating one or more possible changes in the enterprise elements and/or structural rules. The model is configured to receive the specification associated with the enterprise, and determines impact of the specification on the enterprise. The impact is determined according to the specification, the plurality of enterprise elements, the one or more structural rules and the one or more impact rules. The model is operative to be executed on a processor device. For example, the model may be a stable model comprising logic programming.

We now describe an illustrative implementation with respect to SAP services (see, e.g., D. Woods et al, “Enterprise SOA: Designing IT for Business Innovation,” ISBN 13: 978059610238, the disclosure of which is incorporated by reference herein). Grouped into sets (called bundles), these services have built-in semantics which partition data into an extensible set of BPs and BOs. Below, we adopt SAP to illustrate the application of our approach in an industry scenario with large number of services with complex characteristics.

We implemented the ordering scenario described above using the SAP services publicly accessible from SAP Enterprise Workplace (see https://www.sdn.sap.com/irj/sdn). Specifically, we focused on “Sales Order Processing” (see http://erp.esworkplace.sap.com/socoview), the set of capabilities which “allows sales representatives to easily configure, price, and create sales orders for customers.”

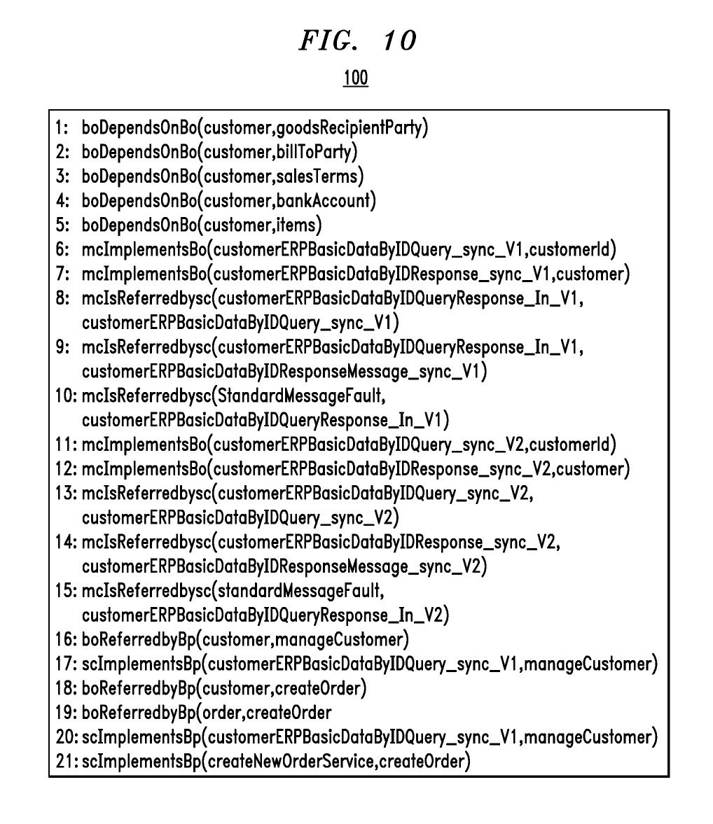

To understand the level of complexity in creating an SOA solution using services like the one offered by SAP, consider that SAP implements a large number of services covering different business processes and industry scenarios. The same process might be offered in different variants (e.g., SAP Workplace lists 11 variants for “Sales Order Processing”). Enterprise services from SAP might be very complex, exposing interfaces (WSDL) with several thousands attributes in input and output. In fact, the approach used by SAP in creating services is to include all possible variations directly as optional elements of the service interface. In our example, if we focus on “the operations that sales employees can use to read or process data about a customer” (manage customer in the Workplace), we can find 15 different operations (each implemented as service) for the BO called customer. Customer is a very complex business object referring to multiple data elements including, among others, company name and address, communication data (phone, email, etc), contact person, bank details, industry sectors, and marketing attributes. Not all 15 services use all attributes of the customer. In fact, as presented in table 90 of FIG. 9, there can be multiple versions of the same service to perform slightly different functionalities on different subsets of the BO data element.

The reason for having multiple versions of the same service is because customizing SAP-based services to meet specific user requirements is a complex and tedious task. The user has to: (a) identify the service(s) to be enhanced, (b) extend the corresponding BO or BP, and (c) choose among different versions of the same service to find the one which fits better with the new requirement, and (d) write the corresponding code to model the new behavior. More importantly, if the enhanced BO is used in multiple services, developer has to manually identify and then implement the code for all affected services to ensure consistent behavior.

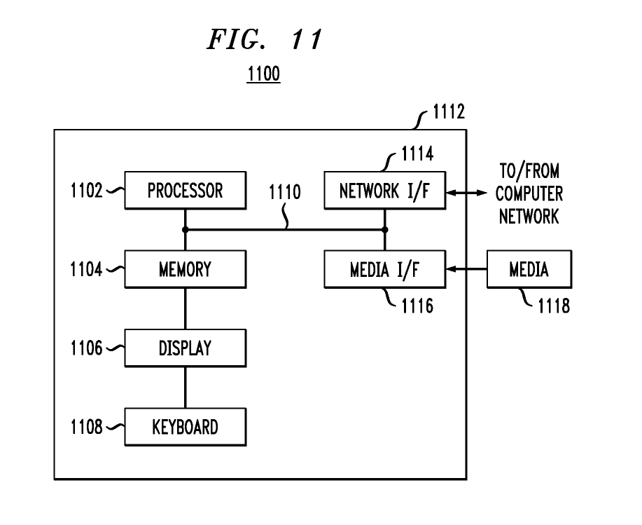

FIG. 10 shows a very small fragment of structural rules (100) which have been built using our system for the actual SAP services. In the figure, a BP createOrder creates new orders for the customer. CreateOrder composes service customerERPBasicData ByIDQuery_sync_V1, from SAP, and service createNewOrderService, from the specific back-end system used for billing.

In the example, facts and structural rules modeling the IT elements of the SOA solution have been automatically generated by parsing the interfaces of the services available in the service registry (e.g., IBM Web Service Registry and Repository—WSRR). On the other hand, we look at process model documentation (such as the one generated by IBM Websphere Business Modeler-WBM) to create facts and structural rules related to the business.

In what follows, we describe, using an example, how our model can help an organization to identify all services and processes affected by a business change.

### EXAMPLE 4

New Requirement: Remove bank account from BO Customer as transactions are always paid cash or via credit card.

Question: Which are the services to be changed as result of the requirement?

This question can be easily answered by our model. First, the system architect defines the requirement as new fact for the model. In the example, the fact changeBusObj (BankAccount) is defined. Second, the customization analyzer 62 (FIG. 6) computes the stable model given in input facts, structural and impact rules. Impact Rule No. 1 propagates change (BankAccount) to BO Customer and from there, rule No. 2, propagates it to BP CreateOrder. The same process is continued for the IT elements of the model.

At anytime, the customization analyzer can trace the impact rules from which a given fact is inferred. As example, it can distinguish (a) the SCs which should change because a referred MC changes (impact rule No. 14 in FIG. 10) from (b) the SCs which should change because the implemented BP changes (impact rule No. 8 I FIG. 10). Similarly, it can identify which SCs are implementing a BP (structural rule No. 17 in FIG. 10). A system architect can now identify which services should be changed even thought they do not implement any BP (customerERPBasicDataBylDQuery_sync_V2) and decide not to change them as result of the new business requirement. Such information can also be used to identify which versions of the same service exist and which one need to be changed to address the new requirement. This allows keeping fewer versions of the same service and to remove them when not longer in the business.

Until now, we have described how our approach can be used to determine the extent of change in a SOA implementation as necessitated by business requirements. Some representative approaches for customization from different disciplines are: artificial intelligence, semantic web, graph theory, and Petri Nets.

An organization is likely to integrate services from multiple parties, each with a different approach to customization. In this context, it is very difficult to identify which are the actual tasks to be performed on the system and to estimate the overall cost of implementing the business requirement. Aspects of the invention can be used to answer many other IT and business questions including: (a) if some existing services will be customized, determine what are the choices and associated costs and (b) determine whether new IT services should be created or existing ones be customized. The two questions are closely related as there exists multiple approaches to customize an element of the model and each alternative might be associated with a different cost. As an example, the cost of changing the logic of a SC is different depending on if such a logic is defined externally to the composed service using a workflow specification language (such as BPEL) or tightly coupled (hard-coded) on it. Approaches according to embodiments of the invention can address this problem as the model can be extended to consider costs and customization requirements as facts for the IT elements composing specific SOA implementation.

The customization analyzer is able to compute the overall cost of the new business requirement by simply considering the cost of all affected elements. This will be very valuable information for the business in order to estimate the cost of the operation. The system architects can use such information to properly choose the customization approach for the services they integrate in a SOA solution depending on the customization requirement it might be subjected to during its lifecycle.

Related to the notion of customization are the concepts of personalization and adaptation of web services. In one personalization approach, a general information service may provide different types of information specific to individual users using RS S (Really Simple Syndication), see, e.g., S. Abiteboul et al., “Schema Driven Customization of Web Services,” Proc. VLDB 2003, the disclosure of which is incorporated by reference herein. The generic schema is published and by selecting specific sections, the system can personalize the content. In this approach, the service is made specific to the user at runtime and an instance of the service is not created specifically for the user. In adaptation of web services, the behavior of a deployed web service may be modified at runtime based on environmental considerations. Adaptation may already assume that the available service met requirements of a user and that the user wants to ensure this continues as the environment changes. Adaptation approaches may, for example, come in two main forms—one where the primary aim is to compose and deploy a correct workflow, and adaptation is viewed as an afterthought (see, e.g., T. C. Au et al., “Web Service Composition with Volatile Information,” International Semantic Web Conference 2005, 52-66, the disclosure of which is incorporated by reference herein); and another where adaptation issues are viewed while composing workflows (see, e.g., G. Chafle et al., “Improved Adaptation of Web Service Compositions Using Value of Changed Information,” Proc. ICWS, Salt Lake City, USA. 2007, the disclosure of which is incorporated by reference herein).

Motivated by the need to determine the overall impact of a new requirement in a complex SOA environment, the notion of business driven customization of SOA has been introduced. A formal model capturing properties and relationships of business objects and business processes, and their implementing services and messages has also been introduced. The implementation of principles of the invention in multiple setting has been described, and application in an industry scenario with large number of services with complex characteristics (SAP) has been illustrated. Though the approach was illustrated with web services, the approach is relevant for SOA in general. The inventive approach provides a valuable, explicit model of alignment between business processes to service-based IT implementations.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Referring again to FIGS. 1 through 10, the diagrams in the Figures illustrate the architecture, functionality, and operation of possible implementations of systems, methods and computer program products according to various embodiments of the present invention. In this regard, each block in a flowchart or a block diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagram and/or flowchart illustration, and combinations of blocks in the block diagram and/or flowchart illustration, can be implemented by special purpose hardware-based systems that perform the specified functions or acts, or combinations of special purpose hardware and computer instructions.

Accordingly, techniques of the invention, for example, as depicted in FIGS. 1-10, can also include, as described herein, providing a system, wherein the system includes distinct modules (e.g., modules comprising software, hardware or software and hardware). By way of example only, the modules may include: a specification obtaining module configured to obtain an enterprise specification or a change in an enterprise specification associated with an enterprise (e.g., an enterprise to use, implement, or customize services); an element determining module configured to determine a plurality of enterprise elements; a structural rule formation module configured to form one or more structural rules stating relationships among the plurality of enterprise elements; an impact rule obtaining module configured to obtaining one or more impact rules indicating one or more possible changes associated with the enterprise (e.g., changes in the plurality of enterprise elements and/or the one or more structural rules); and an impact determining module configured to determine impact of the specification or the change in the specification on the enterprise, wherein the impact is deteimined according to the specification or the change in the specification, the plurality of enterprise elements, the one or more structural rules and the one or more impact rules. By way of further examples only, the modules may alternately or additionally include: a customization analyzer module (e.g., 62 of FIG. 7); a fact builder module (e.g., 63 of FIG. 7); an impact propagation rules module (e.g., 69 of FIG. 7); and a registries module (e.g., 64 of FIG. 7). Optionally, there may be additional modules including, for example, a service matcher module (e.g., 71 of FIG. 7) and a service composition module (e.g., 72 of FIG. 7). These and other modules may be configured, for example, to perform the steps of described and illustrated in the context of FIGS. 1-10.

One or more embodiments can make use of software running on a general purpose computer or workstation. With reference to FIG. 11, such an implementation 1100 employs, for example, a processor 1102, a memory 1104, and an input/output interface formed, for example, by a display 1106 and a keyboard 1108. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, keyboard or mouse), and one or more mechanisms for providing results associated with the processing unit (for example, display or printer). The processor 1102, memory 1104, and input/output interface such as display 1106 and keyboard 1108 can be interconnected, for example, via bus 1110 as part of a data processing unit 1112. Suitable interconnections, for example, via bus 1110, can also be provided to a network interface 1114, such as a network card, which can be provided to interface with a computer network, and to a media interface 1116, such as a diskette or CD-ROM drive, which can be provided to interface with media 1118.

A data processing system suitable for storing and/or executing program code can include at least one processor 1102 coupled directly or indirectly to memory elements 1104 through a system bus 1110. The memory elements can include local memory employed during actual execution of the program code, bulk storage, and cache memories which provide temporary storage of at least some program code in order to reduce the number of times code must be retrieved from bulk storage during execution. The data structure that constitutes the model used to determine the impact of customization, as described in detail herein, is stored in and accessible from one or more of the memory elements.

Input/output or I/O devices (including but not limited to keyboard 1108, display 1106, pointing device, and the like) can be coupled to the system either directly (such as via bus 1110) or through intervening I/O controllers (omitted for clarity).

Network adapters such as network interface 1114 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 1112 as shown in FIG. 11) running a server program. It will be understood that such a physical server may or may not include a display and keyboard.

It will be appreciated and should be understood that the exemplary embodiments of the invention described above can be implemented in a number of different fashions. Given the teachings of the invention provided herein, one of ordinary skill in the related art will be able to contemplate other implementations of the invention. Indeed, although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for determining an impact of a change in a specification on one or more services associated with an enterprise, the method comprising:
obtaining the change in the specification associated with the enterprise, wherein the specification represents a capability of the enterprise to satisfy a service request;
obtaining a plurality of enterprise elements, wherein the enterprise elements are components of the enterprise;
obtaining one or more structural rules stating relationships among the plurality of enterprise elements;
obtaining one or more pre-defined impact rules indicating one or more possible changes associated with the enterprise, the one or more pre-defined impact rules having been pre-defined independent of the one or more services associated with the enterprise;
wherein the plurality of enterprise elements, the one or more structural rules, and the one or more pre-defined impact rules are stored in a data structure in the form of a model such that the enterprise elements from a non-technical domain of the enterprise and the enterprise elements from a technical domain of the enterprise that are used to implement the enterprise elements of the non-technical domain, and dependencies there between, are represented in the model, and wherein the enterprise elements from the technical domain represent components of a system architecture used to realize the enterprise elements of the non-technical domain; and
determining the impact of the change in the specification on the one or more services, wherein the impact is determined according to the change in the specification and the model which comprises the plurality of enterprise elements, the one or more structural rules, and the one or more pre-defined impact rules, such that when an enterprise element changes in the model based on the obtained specification change, one or more of the impact rules are used to propagate the change across the model to identify which enterprise elements across the multiple domains are affected;
wherein one or more of the obtaining of the change in the specification, the obtaining of the plurality of enterprise elements, the obtaining of the one or more structural rules, the obtaining of the one or more pre-defined impact rules, the forming of the model, and the determining of the impact are implemented as instruction code executed on a processor device.

2. The method of claim 1, further comprising selecting to implement one or more possible changes related to the one or more services, the one or more possible changes resulting from the determining of the impact of the change in the specification on the one or more services.

3. The method of claim 1, further comprising determining which one or more existing services for the enterprise to at least one of: (i) use; (ii) obtain; and (iii) customize.

4. The method of claim 1, wherein the plurality of enterprise elements comprises at least one of: (i) an enterprise object; (ii) an enterprise scenario; (iii) an enterprise process; (iv) enterprise logic describing the enterprise process; (v) a service; (vi) a service container referring to at least one service; (vii) service logic describing a process flow among the at least one service; (viii) a message; (ix) a message container; and (x) an enterprise fact, and wherein the enterprise scenario describes at least one of: (i) what the enterprise does, and (ii) how the enterprise functions.

5. The method of claim 4, wherein an enterprise process is associated with at least one of: (i) an enterprise object; (ii) a service container, (iii) a message container, (iv) service logic, and (v) enterprise logic.

6. The method of claim 4, wherein the enterprise fact represents a claim related to the enterprise, wherein the claim may be true or false.

7. The method of claim 6, wherein the claim related to the enterprise is a claim about at least one of (i) an enterprise object; (ii) an enterprise process; (iii) an enterprise implemented service; and (iv) an enterprise message.

8. The method of claim 1, wherein the one or more pre-defined impact rules are defined using at least one of: (i) logic programming; and (ii) a stable model.

9. The method of claim 1, wherein the one or more services comprise one or more of: (i) a service provided over a network; (ii) a service provided over the Internet; and (iii) a service associated with a service oriented architecture.

10. The method of claim 1, wherein the change in the specification comprises at least one of: (i) a change related to the enterprise; (ii) a new enterprise specification; (iii) a customization of services requirement; (iv) an enterprise element; (v) an enterprise fact; (vi) a change in a business object; and (vii) a change in a business process.

11. The method of claim 1, wherein the one or more pre-defined impact rules indicate at least one of: (i) an aspect of the enterprise which may be affected by the change in the specification; (ii) a task which could be implemented by the enterprise to meet the change in the specification; (iii) how to modify output content from the one or more services to meet the change in the specification; and (iv) how to modify behavior of the one or more services to meet the change in the specification.

12. The method of claim 1, wherein the one or more pre-defined impact rules relate to at least one of: (i) a business domain; and (ii) an information technology domain.

13. The method of claim 1, wherein the obtaining of the plurality of enterprise elements and the obtaining of the one or more structural rules is according to one or more registries comprising at least one of: (i) known enterprise objects; (ii) known enterprise processes; (iii) known enterprise services; and (iv) known messages.

14. The method of claim 1, wherein the enterprise comprises a business, and the plurality of enterprise elements comprise a plurality of business elements.

15. The method of claim 1, wherein the obtaining of the change in the specification associated with the enterprise comprises a new fact comprising a new claim related to the enterprise.

16. The method of claim 1, wherein the obtaining of the one or more pre-defined impact rules comprises forming the one or more pre-defined impact rules according to at least one of: (i) the plurality of enterprise elements, (ii) the one or more structural rules, and (iii) a stable model.

17. The method of claim 1, wherein the one or more possible changes associated with the enterprise comprise changes in at least one of: (i) the plurality of enterprise elements; and (ii) the one or more structural rules.

18. A system for determining an impact of a change in a specification on one or more services associated with an enterprise, the system comprising:
a specification obtaining module configured to obtain the change in the specification associated with the enterprise, wherein the specification represents a capability of the enterprise to satisfy a service request;
an element obtaining module configured to determine a plurality of enterprise elements, wherein the enterprise elements are components of the enterprise;
a structural rule formation module configured to form one or more structural rules stating relationships among the plurality of enterprise elements;
an impact rule obtaining module configured to obtain one or more pre-defined impact rules indicating one or more possible changes associated with the enterprise, the one or more pre-defined impact rules having been pre-defined independent of the one or more services to be used by the enterprise;
wherein the plurality of enterprise elements, the one or more structural rules, and the one or more pre-defined impact rules are stored in a data structure in the form of a model such that the enterprise elements from a non-technical domain of the enterprise and the enterprise elements from a technical domain of the enterprise that are used to implement the enterprise elements of the non-technical domain, and dependencies there between, are represented in the model, and wherein the enterprise elements from the technical domain represent components of a system architecture used to realize the enterprise elements of the non-technical domain; and
an impact determining module configured to determine the impact of the change in the specification on the enterprise, wherein the impact is determined according to the change in the specification and the model which comprises the plurality of enterprise elements, the one or more structural rules, and the one or more pre-defined impact rules, such that when an enterprise element changes in the model based on the obtained specification change, one or more of the impact rules are used to propagate the change across the model to identify which enterprise elements across the multiple domains are affected;
wherein one or more of the obtaining of the change in the specification, the obtaining of the plurality of enterprise elements, the obtaining of the one or more structural rules, the obtaining of the one or more pre-defined impact rules, the forming of the model, and the determining of the impact are implemented as instruction code executed on a processor device.

19. The system of claim 18, wherein the plurality of enterprise elements comprises at least one of: (i) an enterprise object; (ii) an enterprise scenario; (iii) an enterprise process; (iv) enterprise logic describing the enterprise process; (v) a service; (vi) a service container referring to at least one service; (vii) service logic describing a process flow among the at least one service; (viii) a message; (ix) a message container; and (x) an enterprise fact, and wherein the enterprise scenario describes at least one of: (i) what the enterprise does, and (ii) how the enterprise functions.

20. A data structure for storing a model used for determining an impact of a change in a specification on one or more services associated with an enterprise, the model comprising:
a plurality of enterprise elements, wherein the enterprise elements are components of the enterprise;
one or more structural rules stating relationships among the plurality of enterprise elements; and
one or more pre-defined impact rules indicating one or more possible changes associated with the enterprise, the one or more pre-defined impact rules having been pre-defined independent of the one or more services to be used by the enterprise;
wherein the enterprise elements from a non-technical domain of the enterprise and the enterprise elements from a technical domain of the enterprise that are used to implement the enterprise elements of the non-technical domain, and dependencies there between, are represented in the model, and wherein the enterprise elements from the technical domain represent components of a system architecture used to realize the enterprise elements of the non-technical domain;
wherein the model is configured to receive the change in the specification associated with the enterprise;
wherein the model determines the impact of the change in the specification on the enterprise, wherein the impact is determined according to the change in the specification and the model which comprises the plurality of enterprise elements, the one or more structural rules, and the one or more pre-defined impact rules, such that when an enterprise element changes in the model based on the obtained specification change, one or more of the impact rules are used to propagate the change across the model to identify which enterprise elements across the multiple domains are affected; and
wherein the model is operative to be implemented as instruction code executed on a processor device.

21. The data structure of claim 20, wherein the plurality of enterprise elements comprises at least one of: (i) an enterprise object; (ii) an enterprise scenario; (iii) an enterprise process; (iv) enterprise logic describing the enterprise process; (v) a service; (vi) a service container referring to at least one service; (vii) service logic describing a process flow among the at least one service; (viii) a message; (ix) a message container; and (x) an enterprise fact, and wherein the enterprise scenario describes at least one of: (i) what the enterprise does, and (ii) how the enterprise functions.

22. The data structure of claim 20, wherein the model further comprises at least one of: (i) logic programming; and (ii) a stable model.

23. Apparatus for determining an impact of a change in a specification on one or more services associated with an enterprise, the apparatus comprising:
a memory; and
a processor coupled to the memory and configured to:
obtain the change in the specification associated with the enterprise, wherein the specification represents a capability of the enterprise to satisfy a service request;
obtain a plurality of enterprise elements, wherein the enterprise elements are components of the enterprise;
obtain one or more structural rules stating relationships among the plurality of enterprise elements;
obtain one or more pre-defined impact rules indicating one or more possible changes associated with the enterprise, the one or more pre-defined impact rules having been pre-defined independent of the one or more services associated with the enterprise;
wherein the plurality of enterprise elements, the one or more structural rules, and the one or more pre-defined impact rules are stored in a data structure in the form of a model such that the enterprise elements from a non-technical domain of the enterprise and the enterprise elements from a technical domain of the enterprise that are used to implement the enterprise elements of the non-technical domain, and dependencies there between, are represented in the model, and wherein the enterprise elements from the technical domain represent components of a system architecture used to realize the enterprise elements of the non-technical domain; and
determine the impact of the change in the specification on the one or more services, wherein the impact is determined according to the change in the specification and the model which comprises the plurality of enterprise elements, the one or more structural rules, and the one or more pre-defined impact rules, such that when an enterprise element changes in the model based on the obtained specification change, one or more of the impact rules are used to propagate the change across the model to identify which enterprise elements across the multiple domains are affected.

24. An article of manufacture for determining an impact of a change in a specification on one or more services associated with an enterprise, the article of manufacture tangibly embodying a computer readable program code which, when executed, causes the computer to:
obtaining the change in the specification associated with the enterprise, wherein the specification represents a capability of the enterprise to satisfy a service request;
obtaining a plurality of enterprise elements, wherein the enterprise elements are components of the enterprise;
obtaining one or more structural rules stating relationships among the plurality of enterprise elements;
obtaining one or more pre-defined impact rules indicating one or more possible changes associated with the enterprise, the one or more pre-defined impact rules having been pre-defined independent of the one or more services associated with the enterprise;
wherein the plurality of enterprise elements, the one or more structural rules, and the one or more pre-defined impact rules are stored in a data structure in the form of a model such that the enterprise elements from a non-technical domain of the enterprise and the enterprise elements from a technical domain of the enterprise that are used to implement the enterprise elements of the non-technical domain, and dependencies there between, are represented in the model, and wherein the enterprise elements from the technical domain represent components of a system architecture used to realize the enterprise elements of the non-technical domain; and
determining the impact of the change in the specification on the one or more services, wherein the impact is determined according to the change in the specification and the model which comprises the plurality of enterprise elements, the one or more structural rules, and the one or more pre-defined impact rules, such that when an enterprise element changes in the model based on the obtained specification change, one or more of the impact rules are used to propagate the change across the model to identify which enterprise elements across the multiple domains are affected.

25. The article of manufacture of claim 24, wherein the plurality of enterprise elements comprises at least one of: (i) an enterprise object; (ii) an enterprise scenario; (iii) an enterprise process; (iv) enterprise logic describing the enterprise process; (v) a service; (vi) a service container referring to at least one service; (vii) service logic describing a process flow among the at least one service; (viii) a message; (ix) a message container; and (x) an enterprise fact, and wherein the enterprise scenario describes at least one of: (i) what the enterprise does, and (ii) how the enterprise functions.
